(19) United States
(12) Patent Application Publication
(10) Pub. No.: US 2009/0327624 A1
(43) Pub. Date: Dec. 31, 2009

(54) INFORMATION PROCESSING APPARATUS, CONTROLLING METHOD THEREOF, AND PROGRAM

(75) Inventors: Tetsuya Tamura, Kanagawa (JP); Kazuya Suzuki, Kanagawa (JP); Nobuharu Sasaki, Saitama (JP); Hajime Nishumura, Kanagawa (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 12/493,402

(22) Filed: Jun. 29, 2009

(30) Foreign Application Priority Data
Jun. 30, 2008 (JP) 2008-171766

(51) Int. Cl. G06F 12/00

(52) U.S. Cl. 711/158; 711/E12.016

(57) ABSTRACT

An information processing apparatus controls writing to a disk. A command reception section receives from a host apparatus a write command and a control command controlling a cache about the write command. A queue storage section stores a queue for the write command and the control command received by the command reception section. A control section determines which of a first write command for data of a file and a second write command for metadata corresponding to the file the write command stored in the queue is, groups, when the control command is received by the command reception section, at least one first write command and at least one second write command that have been received and stored in the queue, assigns an execution sequence numbers to the first write command and the second write command in the group such that data write of the first write command to the disk is executed in priority to the data write of the second write command, and controls execution of the first write command and the second write command according to the assigned execution sequence numbers.

### BACKGROUND OF THE INVENTION

1. Field of the Invention

The present invention relates to an information processing apparatus, a controlling method thereof, and a program.

2. Description of the Related Art

When a video stream is recorded to a device having a block I/O, such as a hard disk apparatus or a memory card, using a home apparatus such as a camcorder, a plurality of files are opened first and additional data is then written thereto. Since these files collectively compose a stream, even if a part of the files is destroyed, the stream may be lost for a long period of time.

In contrast, hard disk apparatuses have a write buffer (write cache) for improving a transfer performance. In addition, since the hard disk apparatuses does not have sufficient impact and vibration resistances, the apparatuses tend to have a write cache having as large a capacity as possible in order to stably record data. Thus, if a power failure occurs while data are being written to a hard disk apparatus, since a large amount of data stored in the write cache is lost, a damage becomes serious.

In this regard, a synchronize cache command which causes all pieces of data stored in the write cache to be written to the hard disk apparatus is provided (for example, see Japanese Patent Application Laid-Open No. HEI 6-259198 (hereinafter, referred to as Patent Document 1)). A host apparatus optimally selects a frequency of issuance of the synchronize cache command based on a type and level of importance of data to be transferred. For example, in the case of a video stream and the like, after a write command for one frame of data is issued, a synchronize cache command is issued so that the frame data is securely written to the hard disk apparatus.

According to an embodiment of the present invention, write commands in a queue of a hard disk drive (HDD) are grouped into write commands for files and write commands for metadata so as to optimize the write sequence of the write commands. In contrast, Patent Document 1 describes a technique of retrieving from an entire queue a write command with which an HDD can be accessed in succession to a write command received from a host apparatus.

### SUMMARY OF THE INVENTION

Information about write commands issued from the host apparatus and received by a disk storage apparatus is stored in the queue. The disk storage apparatus reads the information about the write commands from the queue in the sequence of reception and performs a write process with respect to the HDD according to a synchronize cache command. The host apparatus issues, as the write commands, write commands for files and write commands for metadata that represents allocation information and so forth about substantial data of the files. However, there is no guarantee that the write commands for the metadata are always issued by the host apparatus after the write commands for the files, and that the write commands are always written to the HDD in the sequence of issuance. Thus, if a power failure occurs while the synchronize cache command is being executed, there has been a possibility that only the metadata is written to the HDD and the substantial data of the files is not properly written to the HDD. In this case, there has been a fear that an inconsistency in which a file indicated by the metadata thereof to have been recorded is not actually recorded properly occurs, to thus cause a stream of a long period of time to be lost when the stream is composed of a plurality of files.

In view of the foregoing, it is desirable to provide an information processing apparatus, a controlling method thereof, and a program that can minimize a loss of data when a power failure occurs during writing to a disk.

According to an embodiment of the present invention, there is provided an information processing apparatus controlling writing to a disk. The information processing apparatus includes a command reception section, a queue storage section, and a control section. The command reception section receives from a host apparatus a write command and a control command controlling a cache about the write command. The queue storage section stores a queue for the write command and the control command received by the command reception section. The control section determines which of a first write command for data of a file and a second write command for metadata corresponding to the file the write command stored in the queue is, groups, when the control command is received by the command reception section, at least one first write command and at least one second write command that have been received and stored in the queue, assigns an execution sequence numbers to the first write command and the second write command in the group such that data write of the first write command to the disk is executed in priority to the data write of the second write command, and controls execution of the first write command and the second write command according to the assigned execution sequence numbers.

According to the embodiment of the present invention, by determining the write sequence numbers in the group in the queue such that the first write command for the data of the file is written to the disk with priority over the second write command for the metadata, a situation where only the metadata is written to the disk due to the power failure during execution of the control command can be prevented from occurring, to thus prevent an inconsistency in which the file indicated by the metadata thereof to have been recorded is not actually recorded properly. Consequently, a risk of losing a stream of a long period of time can be alleviated.

The first write command may target continuous data. The control section may determine the first write command, that is determined plurally, for writing the data of the file to successive positions in a storage area of the disk, and may assign link information in the queue to the plurality of first write commands. Thus, a write process with respect to the disk can be carried out with the plurality of first write commands being unified as one equivalent write command.

The information processing apparatus may further include a buffer section to store the data of the file of each of the plurality of first write command in the queue. When the command reception section receives a new first write command for writing update data with respect to the data of the file stored in the buffer section, the control section may assign, to the first write command in the queue, information for prohibiting a response to a read command for the data of the file received from the host apparatus. Thus, a problem in which the control section responds to the host apparatus with old data of a non-updated file stored in the buffer section can be prevented.

The disk may be spatially divided into a first storage area in which the data of the file is written and a second storage area in which the metadata is written. The control section may assign the execution sequence number to each of the plurality of first write commands for writing the data of the file to successive positions in the first storage area such that the data of the file is written in the first storage area from a side thereof closer to the second storage area of the disk, and may control execution of each of the plurality of first write commands according to the assigned execution sequence number. Thus, a total seek distance of a head can be deceased.

According to another embodiment of the present invention, there is provided a method of controlling an information processing apparatus controlling writing to a disk. The method includes: receiving from a host apparatus a write command and a control command controlling a cache about the write command and storing the write command and the control command in a queue, determining which of a first write command for data of a file and a second write command for metadata corresponding to the file the write command stored in the queue is, grouping, when the control command is received at the reception step, at least one first write command and at least one second write command that have been received and stored in the queue, assigning an execution sequence number to the first write command and the second write command in the group such that data write of the first write command to the disk is executed in priority to data write of the second write command, and executing the first write command and the second write command according to the assigned execution sequence numbers.

According to another embodiment of the present invention, there is provided a program controlling writing to a disk and causing a computer which is built in an information processing apparatus to function as a command reception section, a queue storage section, and a control section. The command reception section receives from a host apparatus a write command and a control command controlling a cache about the write command. The queue storage section stores a queue for the write command and the control command received by the command reception section. The control section determines which of a first write command for data of a file and a second write command for metadata corresponding to the file the write command stored in the queue is, groups, when the control command is received by the command reception section, at least one first write command and at least one second write command that have been received and stored in the queue, assigns an execution sequence numbers to the first write command and the second write command in the group such that data write of the first write command to the disk is executed in priority to the data write of the second write command, and controls execution of the first write command and the second write command according to the assigned execution sequence numbers.

As described above, according to the embodiments of the present invention, even if a power failure occurs during writing to a disk, a data loss can be minimized.

These and other objects, features and advantages of the present invention will become more apparent in light of the following detailed description of best mode embodiments thereof, as illustrated in the accompanying drawings.

### BRIEF DESCRIPTION OF THE DRAWINGS

FIG. 1 is a block diagram showing a structure of a disk storage apparatus according to an embodiment of the present invention;

FIG. 2 is a diagram showing a structure of a write command;

FIG. 3 is a diagram showing a structure of a synchronize cache command;

FIG. 4 is a schematic diagram describing the FAT 32 file system;

FIG. 5 is a flowchart showing a procedure of a queue;

FIG. 6 is a diagram showing an example in the case where another write command that can access a HDD in succession to a received write command;

FIG. 7 is a diagram describing a structure of the queue;

FIG. 8 is a diagram describing an example of a process of setting a no-return flag; and

FIG. 9 is a diagram describing techniques of determining HDD write sequence numbers of write commands.

### DESCRIPTION OF PREFERRED EMBODIMENTS

Next, with reference to the accompanying drawings, embodiments of the present invention will be described.

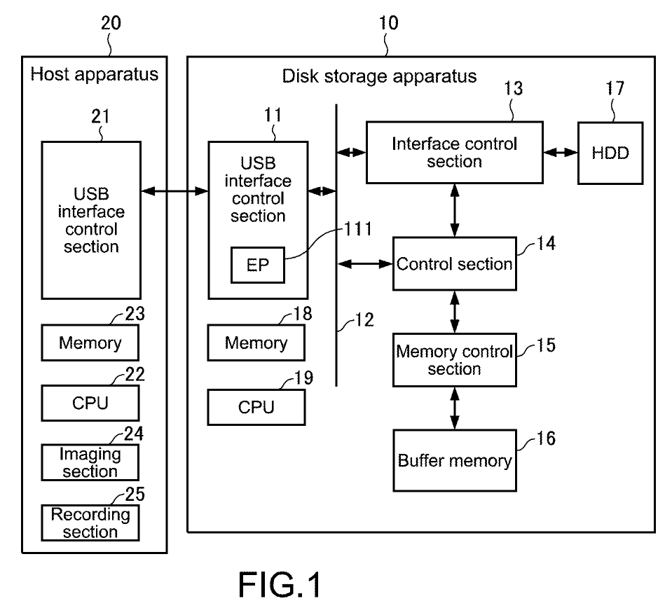

FIG. 1 is a block diagram showing a structure of a disk storage apparatus as an information processing apparatus according to an embodiment of the present invention.

As shown in FIG. 1, a disk storage apparatus 10 according to this embodiment includes a Universal Serial Bus (USB) interface control section 11 (command reception section), an internal bus 12, an interface control section 13, a control section 14, a memory control section 15, a buffer memory 16, a hard disk drive (HDD) 17, a memory 18 (queue storage section), and a central processing unit (CPU) 19.

The USB interface control section 11 is a module that operates in cooperation with a USB interface control section 21 of a host apparatus 20 to control an interface between the disk storage apparatus 10 and the host apparatus 20. The host apparatus 20 is an electronic apparatus such as a video camera or a camcorder and includes, for example, a CPU 22, a memory 23, an imaging section 24, and a recording section 25. The USB interface control section 11 supplies a write command received from the USB interface control section 21 of the host apparatus 20 to the control section 14 through the internal bus 12, and stores write data transferred from the host apparatus 20 in an End point FIFO (EP) 111 of the USB interface control section 11 until the EP 111 becomes full. When the EP 111 becomes full, the USB interface control section 11 transfers the write data to the memory control section 15 through the internal bus 12. The interface between the disk storage apparatus 10 and the host apparatus 20 is not limited to a USB system, and another interface having a transfer rate equal to or higher than that of the USB system, for example, an IEEE 1394 system, may be used.

The internal bus 12 is a transmission path that transmits commands and data between modules of the disk storage apparatus 10.

The memory control section 15 stores the write data obtained from the USB interface control section 11 through the internal bus 12 in the buffer memory 16.

The buffer memory 16 includes a write buffer that temporarily stores write data to be transferred to the HDD 17 and a read buffer that temporarily stores read data that is transferred from the HDD 17 and not yet transferred to the host apparatus 20.

The interface control section 13 is a module that controls an interface between the internal bus 12 and the HDD 17.

The control section 14 stores, in a queue provided in the memory, information about a write command (for example, SCSI Write (10) command) and information about a synchronize cache command that are received from the host apparatus 20, and performs a predetermined process for the information. In addition, asynchronously from this operation, the control section 14 reads information from the queue, converts the information into a write command in a format that the HDD 17 can interpret (for example, an ATA command), and supplies the converted write command to the HDD 17 through the interface control section 13.

The CPU 19 collectively controls the whole disk storage apparatus 10, for example, to exchange commands and data between the modules through the internal bus 12. The memory 18 is used as a work area and so forth for the memory control section 15 and the CPU 19.

The host apparatus 20 issues a write command when data is to be written to the HDD 17.

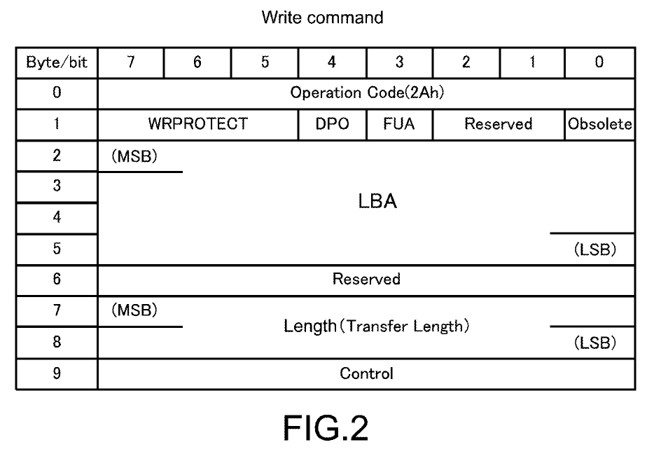

FIG. 2 is a diagram showing a structure of a write command. This write command includes an operation code as command descriptor block (CDB) data that represents a type of a command, Logical Block Addressing (LBA), a length, and so forth. The operation code is a code corresponding to a type of the write command. The LBA is a head logical block address of data to be written to the HDD 17. The length is a length of data to be written to the HDD 17. When the disk storage apparatus receives a write command from the host apparatus 20, the host apparatus 20 stores in the queue information about the write command. The information about a write command stored in the queue will be described later.

In addition, the host apparatus 20 issues a write cache control command called a synchronize cache command that executes all write commands stored in the queue so as to record entire data stored in the write cache on the HDD 17.

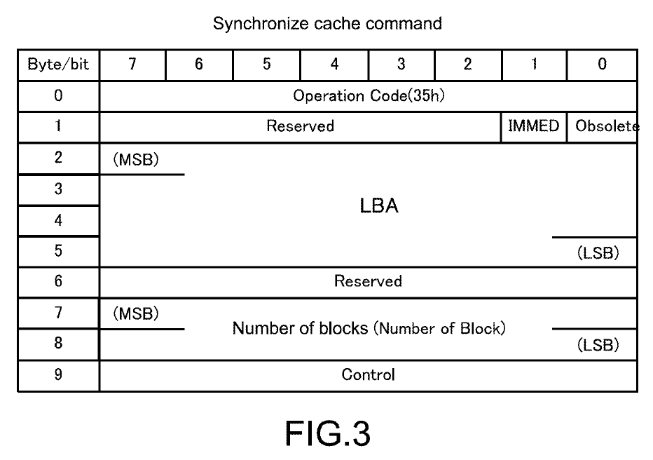

FIG. 3 is a diagram showing a structure of the synchronize cache command. This synchronize cache command includes an operation code as CDB data that represents a type of a command, IMMED, LBA, and the number of blocks. The operation code is a code corresponding to the type of the synchronize cache command. The IMMED is information that designates whether or not the host apparatus 20 is to receive a notification of completion of data write to the HDD 17. When the host apparatus 20 is to receive the notification, “0” is designated. When the host apparatus 20 is not to receive the notification, “1” is designated. That is, in the case of IMMED=0, the host apparatus 20 is incapable of issuing the next write command until the host apparatus 20 receives the notification of completion of data write to the HDD 17. In the case of IMMED=1, the host apparatus 20 can issue the next write command without waiting for the notification of completion of data write to the HDD 17. More specifically, in the case of IMMED=1, at a point when it is confirmed that the start LBA, the length, and so forth designated by each of the write commands that have already been received are valid, the disk storage apparatus 10 sends back a status that represents such a condition, like Good Status, to the host apparatus 20, in order to write the data stored in the write buffer to the HDD 17. The host apparatus 20 checks the status and issues a next write command. The LBA represents the head logical buffer address of data to be written to the HDD 17. The number of blocks represents the number of blocks to be written to the HDD 17. However, if “00h” is designated as the number of blocks, all pieces of data stored in the write cache are written to the HDD 17. Next, a case where “00h” is designated as the number of blocks will be described.

To write data to the HDD 17 more securely, it is necessary to designate IMMED=0 and issue a next write command after confirming completion of data write to the HDD 17. However, in this case, there is a problem that the use efficiency of the write cache and the data transfer performance are lowered, or an error immediately occurs if data write to the HDD 17 is temporarily inhibited due to vibrations or the like. Thus, in the host apparatus 20 according to this embodiment, IMMED=1 is designated.

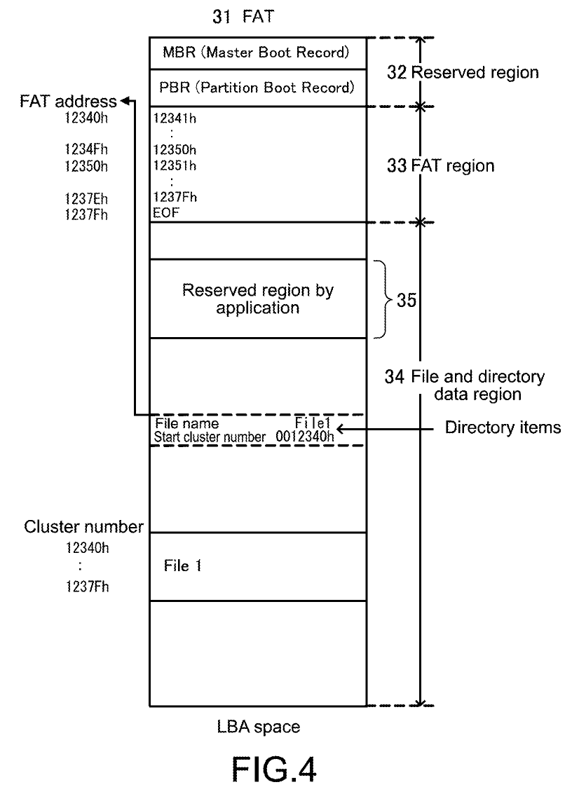

Next, with reference to FIG. 4, a FAT32 file system will be described. In the FAT32 file system, a plurality of sectors (power of two) each a minimum access unit in a disk storage area of the HDD 17 are unified as one cluster to be a minimum file data management unit. Clusters are assigned with cluster numbers in an ascending order of LBA values. In the following description, it is assumed that the cluster numbers are obtained by dividing the LBA values by 16 ignoring an offset (where in an LBA space a cluster with a cluster number 0 is to be allocated). In this case, one cluster is 8 Kbytes.

A file allocation table (FAT) 31 of FIG. 4 is a table recorded with link information indicating in what order the pieces of file data have been stored in what clusters. Thus, in the FAT 31, the cluster numbers are used instead of the LBA values. The storage area managed by the FAT file system is composed of an MBR/PBR region 32, a FAT region 33, and a file and directory data region 34.

The MBR/PBR region 32 is a recording region that stores a master boot record (MBR) and a partition boot record (PBR). The location of the MBR/PBR region 32 in the LBA space is fixed. The FAT region 33 is a region that stores the link information of the cluster numbers of the clusters that store substantial data of the files. The location of the FAT region 33 is also fixed in the LBA space. The file and directory data region 34 is a region that stores the substantial data of the files and directory data (directory items) for organizing and managing the files. The directory items each include, for each file, a file name and a cluster number (start cluster number) at which head of data of a file corresponding to the file name is recorded.

When a file is read, the file system retrieves a file name designated as a read target from the directory items and reads a start cluster number corresponding to the file name. The file system reads data from a cluster designated by the start cluster number. Thereafter, with reference to the FAT region 33, the file system checks the next cluster preceded by the cluster corresponding to the start cluster number, and reads data from the next cluster. Thereafter, in the same manner, with reference to the FAT region 33, the file system reads data from clusters that are successively linked. Finally, upon confirming an End of File (EOF) indicating the end of data of the file from the FAT region 33, the file system stops reading the data of the file.

Each of the directory items also stores meta information such as pointers to a parent directory and child directories, and an access time. In home apparatuses such as a camcorder, application software may cause particular data and directories to be placed in a predetermined LBA range (application reserved region 35).

Next, a description will be given on a process of a queue that is based on write commands and synchronize cache commands received from the host apparatus 20 in the disk storage apparatus according to this embodiment.

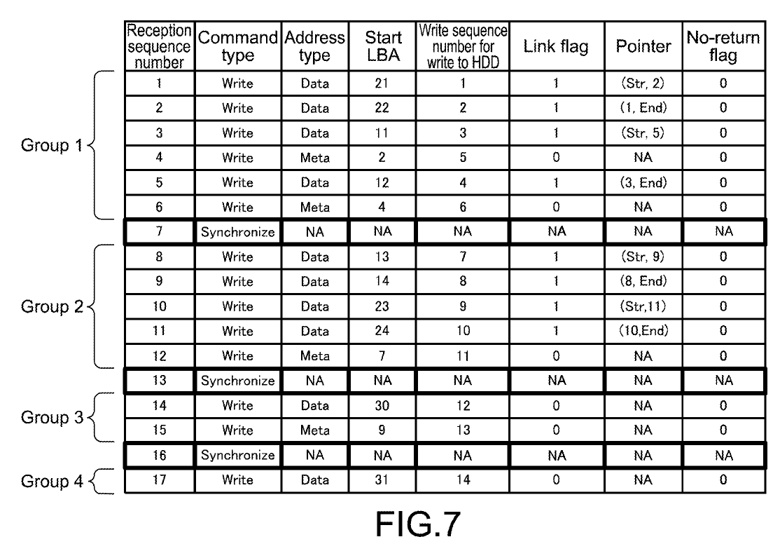

FIG. 7 is a table showing an example of a queue that stores information about the write commands and the synchronize cache commands received from the host apparatus 20.

First, with reference to FIG. 7, a structure of information stored in the queue will be described. Each time a write command or a synchronize cache command is received, information about each command is stored in the queue. The information about each command stored in the queue includes a reception sequence number, a command type, an address type, a start LBA, a write sequence number for write to the HDD 17, a link flag, a link destination pointer, a no-return flag, and the like.

The reception sequence number represents the sequence in which the information has been stored in the queue, namely the reception sequence of the write command or the synchronize cache command received from the host apparatus 20. The command type is information that indicates whether the received command is a write command (Write) or a synchronize cache command (Synchronize). The address type is determined based on the start LBA and the length contained in the received write command, and is information that identifies which of a command for write in the reserved region (FAT region 33) or a command for write in the file and directory data region 34 the received write command is. The write sequence number with respect to the HDD 17 indicates a sequence in which the write process with respect to the HDD 17 is actually executed by the received write command. The link flag is a flag that indicates whether the LBA range designated by the received write command is continuous to the LBA range designated by another write command. If these LBA ranges are continuous, the link flag is set to “1”, and if these LBA are not continuous, the link flag is set to “0”. The link destination pointer is information that represents an entry as a linkage destination of an entry with a link flag=1 and positional relationship thereof. The no-return flag is a flag for inhibiting write data stored in the buffer memory 16 in association with the received write command from being transmitted as a response to a read command received from the host apparatus 20. If the no-return flag is set to “1”, the write data is not transmitted as a response to the read command.

After issuing the synchronize cache command, the host apparatus 20 operates in a mode in which the host apparatus 20 issues a next write command without requiring to be notified of completion of data write to the HDD 17 from the disk storage apparatus (IMMED=1). Thus, there occurs a situation where, after an entry of the synchronize cache command, an entry of the next write command is additionally stored in the queue as shown in FIG. 7, for example.

For example, FIG. 7 shows the queue in the case where six write commands (reception sequence numbers 1 to 6), one synchronize cache command (reception sequence number 7), five write commands (reception sequence numbers 8 to 12), one synchronize cache command (reception sequence number 13), two write commands (reception sequence numbers 14 and 15), one synchronize cache command (reception sequence number 16), and one write command (reception sequence number 17) are successively received.

Here, at least one entry of a write command successively processed based on a synchronize cache command is called a “group”. In other words, in the queue shown in FIG. 7, entries of write commands assigned with reception sequence numbers 1 to 6 are group 1, entries of write commands assigned with reception sequence numbers 8 to 12 are group 2, entries of write commands assigned with reception sequence numbers 14 and 15 are group 3, and an entry of a write command assigned with a reception sequence number 17 is group 4. In this case, a synchronize cache command that requests execution of a write command of the entry of group 4 is not yet received. Thus, thereafter, if the host apparatus 20 issues a new write command, an entry assigned with a reception sequence number 18 is added to the queue, and information about the new write command is stored therein.

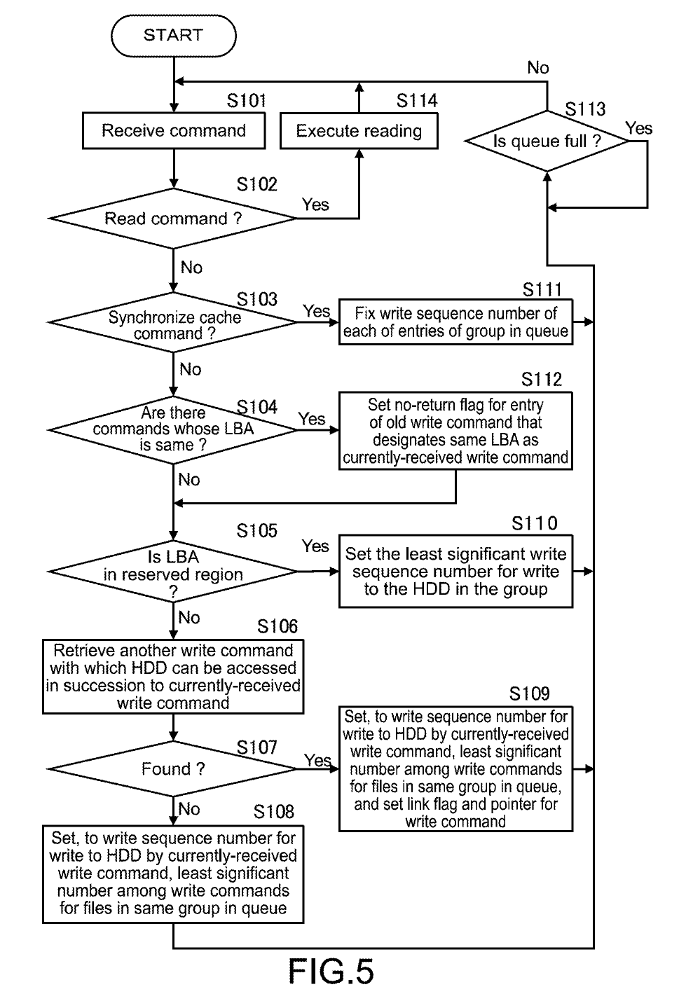

FIG. 5 is a flowchart showing a procedure of the process of the queue with respect to a command issued by the host apparatus 20.

For simplicity, it is assumed that lengths of data designated by write commands are all equal to or smaller than one address block.

First, the control section 14 receives a command issued by the host apparatus 20 through the USB interface control section 11 (Step S101). Here, it is assumed that the command issued by the host apparatus 20 is any one of a write command, a read command, and a synchronize cache command.

The control section 14 determines the type of the received command based on an operation code contained in the received command. If the control section 14 determines that the received command is a write command (NO in Step S102→NO in Step S103), the control section 14 adds a new entry to the queue and stores in the entry a reception sequence number, a command type, and a start LBA.

Thereafter, the control section 14 determines whether or not the LBA range designated by the write command is the same as that designated by a write command of an entry assigned with a fixed sequence number for write to the HDD 17 in the queue (Step S104). In other words, the control section 14 determines whether or not write data corresponding to the currently-received write command is data to be overwritten to write data corresponding to other write commands that are already assigned with fixed write sequence numbers and stored in the queue. The “entries assigned with fixed sequence numbers for write to the HDD 17 in the queue” will be described later.

Next, a case where the LBA range designated by the currently-received write command does not match the LBA range designated by any of write commands of entries assigned with fixed sequence numbers for write to the HDD 17 in the queue will be described (NO in Step S104).

In this case, the control section 14 determines whether or not the LBA range designated by the currently-received command is within the reserved region (FAT region 33) in the LBA space (Step S105). If the LBA range designated by the currently-received write command is within the reserved region, it means that write data corresponding to the write command is metadata that represents information about allocation information, a recording duration, a file size, and so forth of substantial data of a file. In contrast, if not, it means that write data corresponding to the write command is substantial data of a file. In this example, it is assumed that “0” to “10” of the start LBA are the reserved region and “11” and after of the start LBA are the file and directory data region 34.

(Case Where Write Command for File Write is Received)

First, the operation of the control section 14 in the case where write data corresponding to a write command is substantial data of a file will be described (NO in Step S105).

In this case, the control section 14 stores “Data” as the address type in an entry newly added to the queue. Thereafter, the control section 14 retrieves from the last group in the queue another write command with which the HDD 17 can be accessed in succession to the currently-received write command (Step S106). Another write command with which the HDD 17 can be accessed in succession to the currently-received write command is another write command that designates an LBA range continuous to the LBA range designated by the currently-received write command. If another relevant write command is not found (NO in Step S107), the control section 14 sets, to a write sequence number for write to the HDD 17 by the currently-received write command, a least significant number among write commands for files in the same group in the queue, and stores the write sequence number in a new entry in the queue (Step S108).

Thereafter, the control section 14 determines whether or not the number of entries added to the queue is equal to or larger than a predetermined upper limit value (Step S113). If the number of entries added to the queue is smaller than the upper limit value, the control section 14 receives the next command from the host apparatus 20 and performs the same process for the newly received command. If the number of entries added to the queue is equal to or larger than the upper limit value, the control section 14 stops receiving a command from the host apparatus 20 until a space becomes available in the queue.

The control section 14 performs control to execute data write to the HDD 17 based on information of each entry of the oldest group stored in the queue, asynchronous with the reception of the command from the host apparatus 20. Each entry of the group that has been written to the HDD 17 is deleted from the queue. As a result, a next command can be received from the host apparatus 20, and the received command can be stored in the queue.

If the control section 14 has found another write command with which the HDD 17 can be accessed in succession to the currently-received write command (YES in Step S107), the control section 14 sets, to a write sequence number for write to the HDD 17 by the currently-received write command, a least significant number among write commands for files of the same group in the queue, stores the assigned write sequence number in the new entry, and stores link flags and link destination pointers in the new entry and in an entry of another write command with which the HDD 17 can be accessed in succession to the new entry (Step S109). As a result, the process of adding a write command for write data of a file to the queue is completed.

Thereafter, in the foregoing manner, the control section 14 determines whether or not the number of entries added to the queue is equal to or larger than the predetermined upper limit value (Step S113). If the number of entries is smaller than the predetermined upper limit value, the control section 14 receives the next command from the host apparatus 20 and performs the same process for the received command. In addition, if the number of entries is equal to or larger than the predetermined upper limit value, the control section 14 stops receiving the next command from the host apparatus 20 until a space becomes available in the queue.

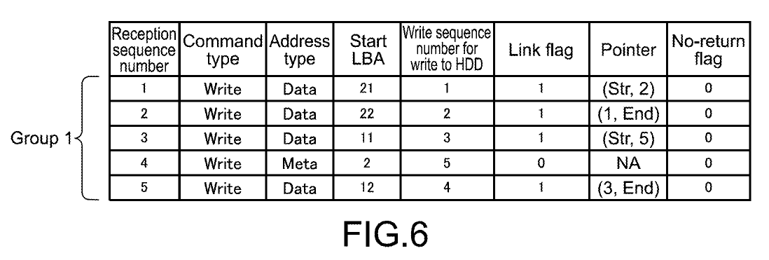

FIG. 6 is a diagram showing an example in which the queue is updated when another write command with which the HDD 17 can be accessed in succession to the currently-received write command is found. An entry of a write command assigned with the reception sequence number 5 is a newly added entry. In the currently-received write command, the address type is “Data” and the start LBA is “12”. On the other hand, in an entry that is assigned with the reception sequence number 3 and belongs to the same group 1 in the queue, the start LBA is “11”. Thus, the control section 14 determines that the entry of the currently-received write command is preceded by the entry assigned with the reception sequence number 3. As a result, link flags and link destination pointers are set for entries assigned with the reception sequence numbers 3 and 5. Moreover, in the entry of the write command assigned with the reception sequence number 4, the address type is “Meta”. Namely, since this entry is an entry of a write command for metadata, the write sequence number for write to the HDD 17 of the entry of the currently-received write command is earlier than that of the entry assigned with the reception sequence number 4. In the example shown in FIG. 6, since three entries of write commands for substantial data of the file are already stored, the sequence number of the entry of the currently-received write command for write to the HDD 17 becomes “4”. Thus, the sequence number of the entry of the write command assigned with the reception sequence number 4 for write to the HDD 17 is lowered from “4” to “5”.

(Case Where Write Command for Metadata is Received)

Next, a description will be given on an operation of the control section 14 in the case where it is determined in Step S105 that the LBA range designated by the write command is within the reserved region (YES in Step S105).

In this case, the control section 14 stores “Meta” as the address type in an entry newly added to the queue. Thereafter, the control section 14 stores the least significant write sequence number for write to the HDD 17 in the group, in the new entry in the queue (Step S110). Thus, the write sequence number of metadata for write to the HDD 17 is assigned with the least significant sequence number in the group.

(Case Where Synchronize Cache Command is Received)

Next, a description will be given on an operation in the case where it is determined in Step S103 that the currently-received command is a synchronize cache command.

The control section 14 stores information about a synchronize cache command in an entry newly added to the queue. In other words, the control section 14 stores “synchronize cache command” as the command type in the entry. Thereafter, the control section 14 fixes a write sequence number for write to the HDD 17 for each of successive entries of write commands that have been added to the queue before the synchronize cache command has been received (Step S111). Thus, the “entries assigned with fixed write sequence numbers for write to the HDD 17 and stored in the queue” as described above are set. After that, the write sequence numbers for write to the HDD 17 assigned to these entries are prohibited from being changed.

Thereafter, in the foregoing manner, the control section 14 determines whether or not the number of entries added to the queue is equal to or larger than the predetermined upper limit value (Step S113). If the number of entries is smaller than the predetermined upper limit value, the control section 14 receives the next command from the host apparatus 20 and performs the same process for the received command. If the number of entries is equal to or larger than the predetermined upper limit value, the control section 14 stops receiving the next command from the host apparatus 20 until a space becomes available in the queue.

Next, a description will be given on a case where it is determined in Step S104 that the LBA range designated by the currently-received write command is the same as the LBA range of one of entries assigned with fixed write sequence numbers for write to the HDD 17 in the queue (YES in Step S104).

In this case, the control section 14 sets a no-return flag for an entry of another write command that designates the same LBA range as the currently-received write command (Step S112). Thereafter, even if the control section 14 receives a read command that designates the same LBA range of the entry from the host apparatus 20 while the entry for which the no-return flag has been set is stored in the queue (YES in Step S102), the control section 14 does not respond to the host apparatus 20 with write data corresponding to the write command of the entry. Instead, the control section 14 responds to the host apparatus 20 with write data corresponding to a new write command (Step S114). Thus, a problem that the control section 14 responds to the host apparatus 20 with old write data of a non-updated file stored in the buffer memory 16 can be prevented.

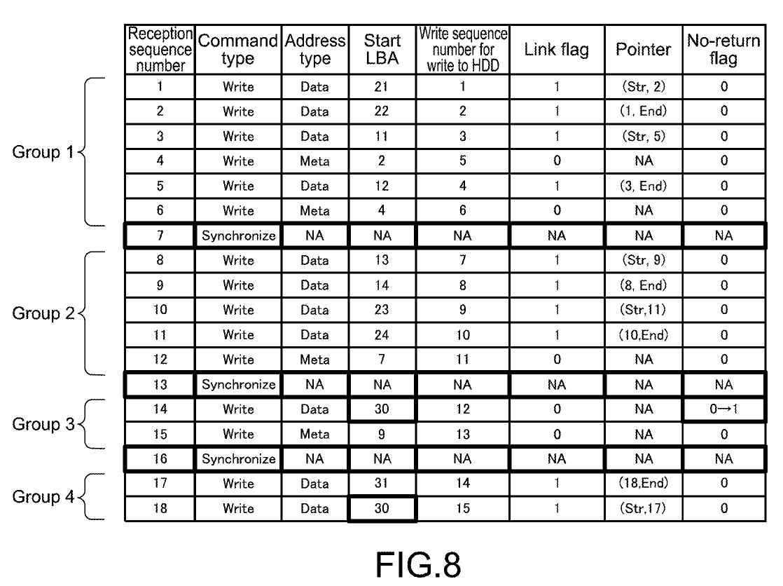

Next, with reference to FIG. 8, an example of a process for setting a no-return flag will be described. The description will be given on a case where a new write command whose start LBA is “30” (reception sequence number 18) is received as shown in FIG. 8, under existence of the queue shown in FIG. 7. In this case, the control section 14 checks whether or not the LBA range designated by the currently-received command is the same as that of any of entries already assigned with fixed write sequence numbers for write to the HDD 17 in the queue. As a result, the control section 14 determines that the entry of the write command assigned with the reception sequence number 14 satisfies the condition. In this case, the write sequence number of the entry of the write command assigned with the reception sequence number 14 for write to the HDD 17 is already fixed by the synchronize cache command assigned with the reception sequence number 16. As shown in FIG. 8, the control section 14 sets the no-return flag for the entry assigned with the reception sequence number 14 based on the determined result to prohibit write data stored in the buffer memory 16 in association with the write command from being transmitted as a response to a read command from the host apparatus 20.

If the control section 14 determines that the received command is a read command in Step S102, the control section 14 performs control to immediately execute the read process based on the read command (Step S114).

(Write Operation to HDD Based on Information About Queue)

As described above, in the disk storage apparatus 10, the control section 14 stores information about write commands and synchronize cache commands received from the host apparatus 20 in the queue provided in the memory 18, and performs a predetermined process on the information. Asynchronous with this operation, the control section 14 reads information about the queue, converts the information into a write command in a format that the HDD 17 can interpret, and supplies the write command to the HDD 17 through the interface control section 13. At this point, the control section 14 reads information about write commands of entries of the oldest group (group 1) in the queue and performs control to execute the write process to the HDD 17 based on the write commands. After completing writing based on the write commands of group 1, the control section 14 reads information about write commands of entries of group 2 and performs control to execute the write process based on the write commands. Write commands of entries in each group are successively performed according to write sequence numbers for write to the HDD 17 in the queue. At this point, the control section 14 determines a link relationship of a plurality of write commands in the group based on the link flags and link destination pointers that have been set for the entries of the write commands in the group, and performs control so that the write commands to be linked are each replaced with one equivalent write command and supplied to the HDD 17.

Write sequence numbers for write to the HDD 17 for write commands for files in the same group may be determined by the following two methods.

The first method involves setting write sequence numbers according to a sequence in which write commands are received as shown in the queue of FIG. 7.

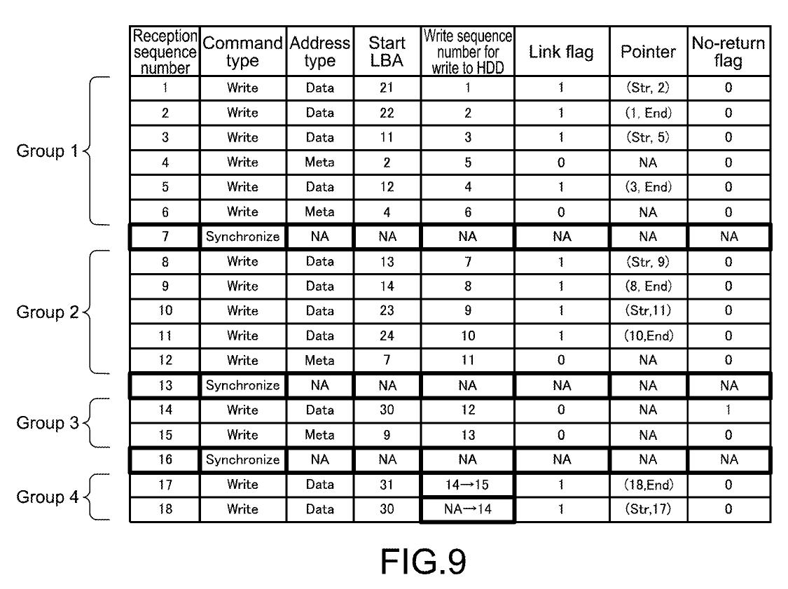

The second method involves sorting write sequence numbers in a group so that seek distances become shorter. FIG. 9 is a diagram describing this method. When the control section 14 receives a new write command, the control section 14 compares a start LBA of the new write command with that of another write command in the same group, and sets the write command having a smaller start LBA value, that is, the write command whose start LBA is closer to the head LBA, to be prioritized over the other. In the example shown in FIG. 9, since the start LBA of the new write command (reception sequence number 18) is “30” and the start LBA of the other write command (reception sequence number 17) in the same group is “31”, the control section 14 assigns to the new write command (reception sequence number 18) a write sequence number for write to the HDD 17 that is higher in priority than that of the other write command (reception sequence number 17). Thus, the write sequence number of the other write command (reception sequence number 17) for write to the HDD 17 is lowered from “14” to “15”, and the write sequence number of the new write command (reception sequence number 18) for write to the HDD 17 is set to “14”.

By thus setting a write command having a smaller start LBA value with a write sequence number for write to the HDD 17 that is higher in priority, the total seek distance of the head can be decreased. This is because, in the write process for the preceding group, the reserved region closest to the head LBA is often written with metadata last.

According to this embodiment, the following effects can be obtained.

Generally, information about write commands is added to the queue in the sequence in which the commands have been received from the host apparatus, and the write process to the HDD is carried out by reading the information about the write commands from the queue in the sequence in which the commands have been received according to a synchronize cache command. At this point, the host apparatus issues write commands for files and write commands for metadata representing allocation information, recording durations, file sizes, numbers of frames, and so forth of substantial data of the files. However, there is no guarantee that the host apparatus always issues the write commands for the metadata after the write commands for the files, and that write to the HDD is always carried out in the sequence of issuance. For example, metadata of a write command assigned with the reception sequence number 12 in FIG. 7 is metadata representing allocation information, recording durations, file sizes, and so forth of substantial data of files of write commands assigned with the reception sequence numbers 8 to 11. However, in general, the host apparatus does not always issue the write command for the metadata after the write commands for substantial data of the files. Thus, there has been a possibility that, if a power failure occurs during writing, a situation where only the metadata is written to the HDD and the substantial data of the files is not properly written to the HDD occurs. In this case, there has been a fear that an inconsistency in which the files indicated by the metadata thereof to have been recorded are not actually recorded on the HDD properly, to thus cause a stream of a long period time to be lost.

In contrast, a case where only the substantial data of the files is written on the HDD and the metadata is not written on the HDD is equivalent to the case where the substantial data is not written to the HDD. The amount of stream that is lost in this case is smaller than that in a case where only the metadata is written on the HDD to thus cause an inconsistency between the metadata and the substantial data of the files.

According to this embodiment, the write sequence number of a write command for a file for write to the HDD is set to be higher in priority than that of a write command for metadata. Thus, even if a power failure occurs while a synchronize cache command is being executed, a situation where only the metadata is written to the HDD can be prevented. As a result, an inconsistency in which files indicated by metadata thereof to have been recorded are not actually recorded on the HDD properly can be prevented. Consequently, a risk of losing a stream of a long period of time can be alleviated. In addition, since the number of seek times of the head moved between the FAT region 33 and the file and directory data region 34 is decreased, the data transfer rate can be improved.

In addition, according to this embodiment, a plurality of write commands for writing substantial data of files in successive LBA ranges of the storage area of the HDD are determined, and link flags and link destination pointers are stored in individual entries of these commands in the queue. As a result, a plurality of write commands can be unified as one equivalent write command to be written to the HDD 17.

In the foregoing embodiment, the case of IMMED=1 has been described. However, this embodiment is also effective in a case of IMMED=0 where, after having confirmed completion of data write to the HDD 17, the host apparatus 20 issues a next write command.

The present application contains subject matter related to that disclosed in Japanese Priority Patent Application JP 2008-171766 filed in the Japanese Patent Office on Jun. 30, 2008, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

1. An information processing apparatus controlling writing to a disk, comprising:
a command reception section to receive from a host apparatus a write command and a control command controlling a cache about the write command;
a queue storage section to store a queue for the write command and the control command received by the command reception section; and
a control section to determine which of a first write command for data of a file and a second write command for metadata corresponding to the file the write command stored in the queue is, group, when the control command is received by the command reception section, at least one first write command and at least one second write command that have been received and stored in the queue, assign an execution sequence number to the first write command and the second write command in the group such that data write of the first write command to the disk is executed in priority to data write of the second write command, and control execution of the first write command and the second write command according to the assigned execution sequence number.

2. The information processing apparatus as set forth in claim 1,
wherein the first write command targets continuous data, and
wherein the control section determines the first write command, that is determined plurally, for writing the data of the file to successive positions in a storage area of the disk, and assigns link information in the queue to the plurality of first write commands.

3. The information processing apparatus as set forth in claim 2, further comprising
a buffer section to store the data of the file of each of the plurality of first write commands in the queue,
wherein, when the command reception section receives a new first write command for writing update data with respect to the data of the file stored in the buffer section, the control section assigns, to the first write command in the queue, information for prohibiting a response to a read command for the data of the file received from the host apparatus.

4. The information processing apparatus as set forth in claim 3,
wherein the disk is spatially divided into a first storage area in which the data of the file is written and a second storage area in which the metadata is written, and
wherein the control section assigns the execution sequence number to each of the plurality of first write commands for writing the data of the file to successive positions in the first storage area such that the data of the file is written in the first storage area from a side thereof closer to the second storage area of the disk, and controls execution of each of the plurality of first write commands according to the assigned execution sequence number.

5. A method of controlling an information processing apparatus controlling writing to a disk, comprising:
receiving from a host apparatus a write command and a control command controlling a cache about the write command and storing the write command and the control command in a queue;
determining which of a first write command for data of a file and a second write command for metadata corresponding to the file the write command stored in the queue is;
grouping, when the control command is received at the reception step, at least one first write command and at least one second write command that have been received and stored in the queue;
assigning an execution sequence number to the first write command and the second write command in the group such that data write of the first write command to the disk is executed in priority to data write of the second write command; and
executing the first write command and the second write command according to the assigned execution sequence numbers.

6. A computer-readable storage medium comprising computer-executable instructions that, when executed by a computer, control writing to a disk and cause the computer which is built in an information processing apparatus to function as:
a command reception section to receive from a host apparatus a write command and a control command controlling a cache about the write command;
a queue storage section to store a queue for the write command and the control command received by the command reception section; and
a control section to determine which of a first write command for data of a file and a second write command for metadata corresponding to the file the write command stored in the queue is, group, when the control command is received by the command reception section, at least one first write command and at least one second write command that have been received and stored in the queue when the command reception section receives the control command, assign an execution sequence number to the first write command and the second write command in the group such that the first write command is executed in priority to data write of the second write command, and control execution of the first write command and the second write command according to the assigned execution sequence number.
